(19) United States
(12) Patent Application Publication
(10) Pub. No.: US 2010/0064822 A1
(43) Pub. Date: Mar. 18, 2010

(54) DEVICE FHOR DETECTING TORQUE TRANSMITTED BY A SHAFT

(76) Inventors: Franck Debrailly, Nouzilly (FR); Sebastiano Calvetto, Collegno (IL)

Correspondence Address: SKF USA Inc., 890 Forty Foot Road, PO Box 332, Kulpsville, PA, 19443, US

(21) Appl. No.: 12/312,566

(22) PCT Filed: Nov. 8, 2007
(86) PCT No.: PCT/FR2007/052315

§ 371 Date: Nov. 18, 2009

(30) Foreign Application Priority Data
Nov. 15, 2006 (FR) 0654925

(51) Int. Cl. G01L 3/10

(52) U.S. Cl. 73/862.326

(57) ABSTRACT

A device 10 for detecting torque transmitted by a shaft, comprising a torsion element 11, two encoders 29, 30 connected angularly to opposite ends of the flexible element in torsion, a sensor assembly, and an electronic circuit board 14 supporting the sensor assembly generating a signal representative of the torque exerted on the shaft.

The present invention relates to the field of detecting and estimating the torque in a shaft of a motor vehicle, particularly a steering-column shaft, for example for the purpose of controlling an assistance motor.

In electric assisted-steering systems, the steering wheel torque exerted by the driver, when the vehicle is traveling, is measured by a dedicated torque sensor. The information thus obtained is subsequently processed by a computer in order to determine the torque setpoint that the assistance motor must apply to the steering column. Torque sensors usually have a complex and bulky structure while being awkward to use and calibrate.

Document FR-A-2 848 173 describes a method for establishing the setpoint value to be applied to the steering column of a motor vehicle, in which the information on the steering-wheel torque is obtained by measuring the angle of the steering column, at the steering wheel and at the assistance motor, then comparing the two angle measurements while taking into account the rigidity of the steering column between the two locations of angle measurement.

It is therefore necessary to provide two angle sensors at a distance from one another and to connect them by wires to a computer, thereby generating a relatively high cost and installation complexity.

Document FR-A-2 821 931 describes an analog device for measuring a torsion torque comprising a proof body that can deform in torsion, two electric pulse generating means, two analog magnetic sensors, each capable of delivering quadrature analog signals and an electronic processing device forming an output signal based on the four signals of the two sensors, the output signal being a function of the torque exerted on the shaft. The magnetic pulse generating means are rings with a large number of poles which may be detrimental to the manufacturing costs.

Also known through document EP-A1-1 541 983 is a system for detecting the torque transmitted to a torsion shaft from a housing inside which gearwheels are mounted, from encoders mounted on said wheels, and from sensors mounted axially facing the encoders. In this document, transmission between the torsion shaft and the encoders is by means of the gearwheels, which may harm the angular precision of the measurement. Furthermore, this system is particularly cumbersome in the radial direction.

Also known via document EP-A1-1 382 510 is a system for detecting torque transmitted to a shaft comprising a torsion element, encoders mounted on the torsion element via tubular supports, and sensors mounted with a slight radial air gap relative to the encoders. The encoders are mounted at the end of the tubular supports and at an axial distance from the points for attaching these supports to the shaft. With such a configuration, the generation of false rotation turns of the encoders and of undesirable air-gap variations between the sensors and encoders may occur.

The object of the present invention is to remedy the disadvantages mentioned above.

The present invention proposes a particularly compact, economical, robust and precise device for detecting torque.

In addition it is possible to obtain a device for detecting torque in the form of a subassembly that is easy to install in a steering column.

The device for detecting torque transmitted by a shaft comprises a torsion element furnished with an input portion and an output portion, two encoders, the first being angularly connected to the input portion, the second to the output portion of the torsion element, a sensor assembly interacting with the encoders and configured to transmit a first signal representative of a first parameter of rotation of the input portion of the torsion element and a second signal representative of a second parameter of rotation of the output portion of the torsion element, and a processing means receiving the output signals from the sensor assembly and configured to generate a signal representative of the torque exerted on the flexible element in torsion. The sensor assembly is placed between the encoders and comprises a first side directed toward the first encoder and a second side directed toward the second encoder, the sensor assembly being placed on a fixed element.

The device also comprises two rolling bearings placed inside a casing, the fixed element being placed between the bearings and fixed in the casing; the encoders each being supported by one of the rolling bearings.

The use of bearings between the casing and the shaft of the device in particular allows operation with reduced friction and an excellent control of the air gap between the sensors and the encoders supported by the bearings to be obtained. This contributes to the stability and reliability of the signals transmitted over time.

The encoders are each mounted on one of the bearings resting in the casing, and the fixed element supporting the sensor assembly is fixed into said casing. This therefore gives a precise relative positioning of the encoder elements and sensors. This ensures a very great precision of rotation of the encoders and therefore an excellent control of the air gap between sensors and encoders.

Advantageously, the sensor assembly and the encoders are placed radially between the inner rings and the outer rings of the rolling bearings.

In one embodiment, the rolling bearings support the torsion element, the encoders being placed concentrically relative to said torsion element.

This further promotes the radial compactness of the device. Specifically, its radial bulk can be equal to that of the rolling bearings.

The fixed element may comprise an electronic circuit board supporting the sensor assembly. The electronic circuit board may also comprise means for processing the signals transmitted by the sensor elements of the sensor assembly.

The processing means may be configured to generate an output signal representative of the angular position of at least one of the encoders.

The rolling bearings are provided with a first raceway toward the input portion, and a second raceway toward the output portion of the torsion element, the first encoder being rotationally connected to the first raceway, and the second encoder being rotationally connected to the second raceway.

The first raceway may be arranged in the input portion and/or the second raceway is arranged in the output portion of the torsion element.

The first raceway may be arranged in a first inner ring placed at the input portion and/or the second raceway is arranged in a second inner ring placed at the output portion of the torsion element.

The rolling bearings may comprise an outer ring furnished with two raceways, the electronic circuit board being mounted in the device so as to remain in a fixed position relative to said outer rings.

The first bearing comprises the first inner ring and a first outer ring, the second bearing comprising the second inner ring and a second outer ring, the electronic circuit board being mounted in the device so as to remain in a fixed position relative to said outer rings.

The sensor assembly may comprise a first sensor placed on one side of the electronic circuit board in order to generate the first signal and a second sensor placed on the other side of the electronic circuit board in order to generate the second signal.

A revolution counter may be capable of supplying a signal representative of a number of revolutions of the shaft.

The electronic circuit board may be placed between the encoders.

The first and/or the second sensor may comprise three detection elements.

The electronic circuit may be configured in order to generate an output signal representative of the absolute angular position of at least one of the encoders.

The electronic circuit may be configured in order to generate an output signal representative of the relative angular position of at least one of the encoders and an output signal representative of the absolute angular position of another encoder.

The detection elements may be of the magnetic detector type, for example Hall effect detectors. The electronic circuit board may be in the form of a board of generally annular shape supporting one sensor on one radial face and the other sensor on the opposite radial face. The processing means may comprise a processor.

At least one encoder may comprise a bipolar ring. Each pole may occupy an angular sector of 180°. A sensor furnished with three detection elements associated with a bipolar ring encoder is capable of detecting an absolute angular position, because the precision does not depend on the resolution of the encoder.

The electronic circuit may be capable of outputting a signal representative of the torque and a signal representative of the angular position of one of the encoders, so that one angular position sensor can be removed elsewhere on the steering column while retaining the angular position signal. This takes advantage of a torque sensor for generating an angular position signal. The device performs a dual function of detecting torque and detecting angular position. The electronic circuit may be configured to generate an output signal representative of the absolute angular position of at least one of the encoders.

The revolution counter may be of the type tolerating power supply interruptions, that is to say supplying the number of revolutions of the shaft relative to a reference when the power supply resumes. The revolution counter may comprise a first gearwheel interacting with a second gearwheel rotationally secured to the shaft. The second gearwheel may be furnished with one tooth. The first gearwheel may be furnished with a number of teeth equal to the number of possible revolutions of the shaft from one abutment to the other, or else double the number of possible revolutions of the shaft. The first gearwheel may be magnetically bipolar. The revolution counter may comprise two magnetic sensors capable of detecting the polarity of the closest portion of the first gearwheel. With a first gearwheel whose angular position is moved 90° during a rotation of one revolution made by the shaft, it is therefore possible to ascertain the position of the shaft in terms of number of revolutions.

In one embodiment, the device is incorporated into a steering column support. The steering column comprises a first part connected to the input portion and a second part connected to the output portion.

In another embodiment, the device is incorporated into a steering rack block.

In another embodiment, the device is incorporated into a steering assistance block.

The invention will be better understood on studying the detailed description of some embodiments taken as nonlimiting examples and illustrated by the appended drawings, in which:

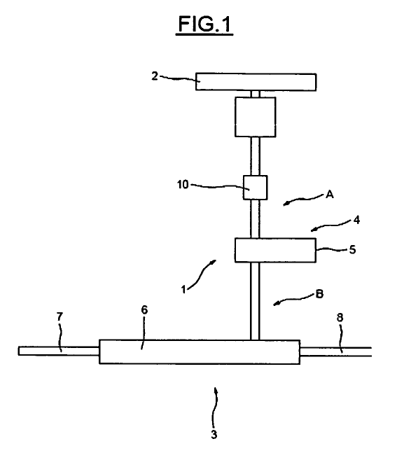

FIG. 1 is a schematic view of a steering column;

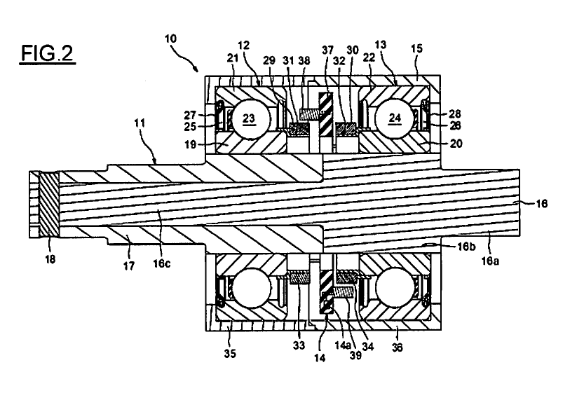

FIG. 2 is a view in axial section of a torque detection device;

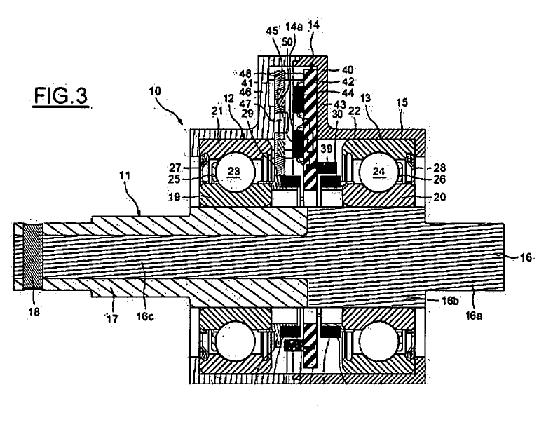

FIG. 3 is a view in axial section of another torque detection device;

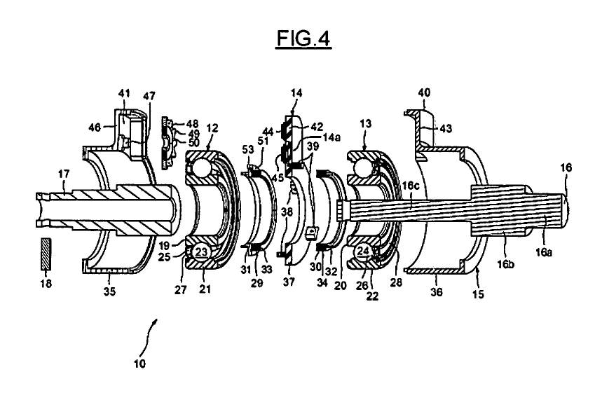

FIG. 4 is an exploded view of FIG. 3;

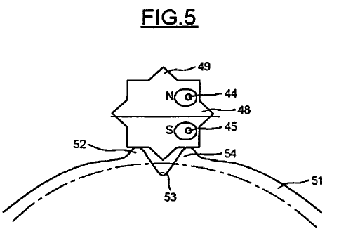

FIG. 5 is a schematic view of a revolution counter;

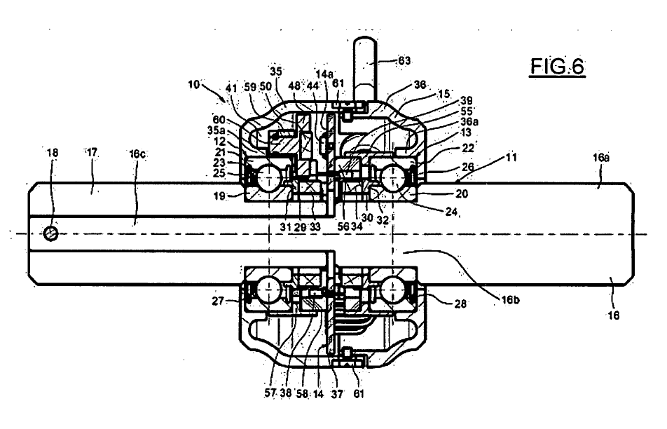

FIG. 6 is a view in axial section of another torque detection device;

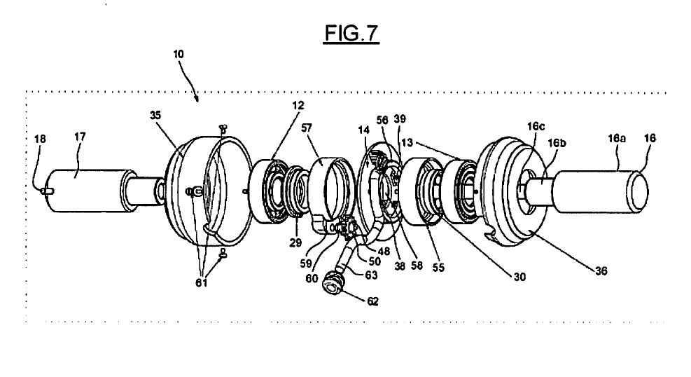

FIG. 7 is an exploded view of FIG. 6; and

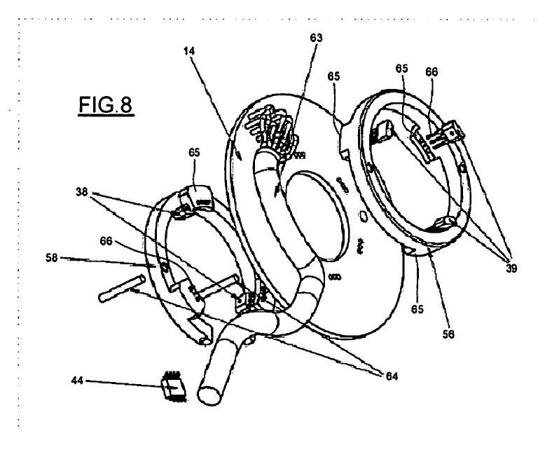

FIG. 8 is an exploded detail view.

As illustrated in FIG. 1, an electric assisted steering system for a vehicle comprises a steering column 1 which supports at its top end a steering wheel 2 capable of being turned by the driver of the vehicle, a mechanical steering device 3 upon which the bottom end of the steering column 1 acts and an assistance motor 4, for example an electric motor, with which a reducing gear 5 may be associated. The mechanical steering device 3 comprises a steering box 6 inside which, axially mobile, is a rack and right and left center links 7, 8, each coupled at one end to the rack and at the other end to the steering device of a front wheel of the assembly. The rack is moved axially by a pinion rotationally secured to the bottom end of the steering column 1. Since the steering wheel 2 is mounted secure in rotation to the top end of the steering column 1, rotating the steering wheel 2 causes the axial movement of the center links 7, 8. The steering column 1 is furnished with a device 10 for detecting the torque transmitted by the shaft, placed at a point on the column situated between the steering wheel and the steering assistance motor, so that the torque exerted on the steering wheel by the driver of the vehicle is detected with the greatest possible precision.

As illustrated in FIG. 2, the device 10 for detecting torque comprises a cartridge, in which these various consecutive elements are placed. The device 10 for detecting torque comprises an element 11 that is flexible in torsion, two rolling bearings 12 and 13, an electronic circuit board 14 and a cartridge casing 15 or cartridge housing. The element 11 that is flexible in torsion comprises an input piece 16, in the form of a shaft, comprising a first part 16a protruding axially relative to the casing 15 and designed to be connected at its free end to a steering column shaft part, not shown; a central part 16b, of larger diameter than the part 16c, onto which the rolling bearing 13 is sleeve-fitted, and a small-diameter part 16c offering a certain degree of elasticity in torsion, which may be determined by its diameter, its length, and the material forming said part 16c, for example a light alloy or else a steel of a chosen grade.

The element 11 that is flexible in torsion also comprises a sleeve 17 in the form of a hollow shaft placed around the small-diameter part 16c of the piece 16 and of substantially equal length, rotationally coupled close to the free end of the small-diameter part 16c by a pin 18 placed in holes passing through the sleeve 17 and the small-diameter part 16c. Naturally, other methods of connection between the free end of the small-diameter part 16c and the free end of the sleeve 17 could be envisaged, for example a weld. The rolling bearing 12 is sleeve-fitted onto an outer cylindrical surface of the sleeve 17, on the side opposite to the pin 18. The opposite part of the steering-column shaft may be connected to the free end of the small-diameter part 16c or to the sleeve 17, in a manner not shown.

In the embodiment illustrated, the sleeve 17 has a tiered outer surface with a greater thickness level at the rolling bearing 12, and a lesser thickness axially at the pin 18. The sleeve 17 has a relatively high torsional stiffness, such that most of the torsional elasticity is supplied by the small-diameter portion 16c of the piece 16. The small-diameter portion 16c is adjusted in the sleeve 17 so as to allow a relative angular movement between the small-diameter part 16c and the sleeve 17 when the portion 16c is subjected to a torsion, said angular movement going from a zero value in the zone of the pin 18 to a maximum value toward the fixed end of the sleeve 17. When a torque is exerted between one end and the other of the piece 16, the angular difference between the sleeve 17 and the large-diameter portion 16b of the piece 16 is a function of said exerted torque.

The rolling bearings 12 and 13 may have identical structures. The rolling bearings 12 and 13 each comprise an inner ring 19, 20, an outer ring 21, 22, an array of rolling elements 23, 24, in this instance balls, a cage 25, 26 for maintaining the even circumferential spacing of the rolling elements 23, 24, and a sealing flange 27, 28 mounted in a groove arranged in the bore of the outer ring 21, 22 and forming a narrow passageway with an outer cylindrical surface of the inner ring 19, 20. The flanges 27 and 28 are placed opposite to one another. The raceways, of toroidal shape in meridian axial section, are arranged in the outer cylindrical surfaces of the inner rings 19, 20, and the bores of the outer rings 21, 22.

The rolling bearings 12 and 13 each comprise an encoder 29, 30. Each encoder 29, 30 comprises a support part 31, 32 and an active part 33, 34. The support part 31, 32 comprises a portion sleeve-fitted onto an outer surface of the inner ring 19, 20 on the side respectively opposite to the flanges 27, 28. In other words, the encoders 29, 30 are placed facing one another. The support part 29, 30 also comprises an axial extension beyond the transverse surface of the inner rings 19, 20, placed at least partly in the active parts 33, 34. The support part 31 may also comprise a radial collar extending radially outward and forming a narrow passageway with the radial transverse surface of the outer ring 21 to enhance the seal of the rolling bearing. The active part 33, 34 may have the shape of a bipolar magnetic ring, each pole occupying an angular sector of 180°. The active part may comprise a “plasto” or a magnetized elasto-ferrite element of rectangular section. The encoders 29, 30 are placed radially between the inner rings 19, 20 and the outer rings 21, 22. More precisely, the encoders 29, 30 are placed between the bores of the inner rings 19, 20 and the outer rings 21, 22. The encoders 29, 30 are situated at one and the same radial distance from the torsion element. In other words, the encoders 29, 30 are placed concentrically relative to the torsion element 11.

The casing 15 in this instance comprises two parts 35, 36 designed to fit into one another and be fixed by sleeve-fitting, by bonding or by mechanical fixing means. Each part 35, 36 of the casing 15 has the shape of an L-section cup, with a large-dimension axial part in which the outer ring 21 of the rolling bearing 12 and the outer ring 22 of the rolling bearing 13 are sleeve-fitted and a short radial edge directed inward and against which the outer rings 21 and 22 butt. In the space defined radially between the outer surfaces of the large-diameter part 16b of the piece 16 and of the outer surface of the sleeve 17, on the one hand, and the bore of the casing 15, on the other hand, and axially between the transverse surfaces of the rolling bearings 12 and 13, are placed on the one hand the encoders 29 and 30 protruding at least partly relative to said transverse surfaces of the rings of the rolling bearings 12 and 13 and, on the other hand, the electronic circuit board 14, for example fixed in the bore of the part 36 of the casing 15 and supported by said part 36.

The electronic circuit board 14 may comprise an annular board 37 extending radially inward from the casing 15 to which it is fixed, and a plurality of sensor elements 38 placed on the side of the rolling bearing 12, around the active part 33 of the encoder 29 with a slight radial air gap. The electronic circuit board 14 and the sensors 38 and 39 that it supports are therefore fixed relative to the casing 15 and to the outer rings 21 and 22 of the bearings 12 and 13. The sensor elements 38 may be of the Hall effect type, for example three in number evenly distributed over the circumference, and thereby form a sensor of absolute angular position. The three sensor elements 38, which sense the magnetic field supplied by the bipolar ring of the active part 33 of the encoder 29, therefore generate three signals which are combined and processed to form two signals the differential measurement of which determines the absolute angular position to the most accurate degree of measurement, of the encoder 29 and therefore of the inner ring 19 and of the sleeve 17 relative to the electronic circuit board 14 and to a fixed reference position. Such a detection system is described in patent application FR 0600120.

On the side of the rolling bearing 13, the electronic circuit board 14 comprises a plurality of sensor elements 39, of the same type as the sensor elements 38, placed around the active part 34 of the encoder 30, thereby making it possible to determine absolutely, to the most accurate degree of measurement, the angular position of the encoder 30 and therefore of the inner ring 20 of the rolling bearing 13 and of the large-diameter part 16b of the piece 16. The sensors 38 and 39 are placed radially between the inner rings 19, 20 and the outer rings 21, 22 of the rolling bearings 12, 13. More precisely, the sensors 38 and 39 are placed between the bores of the inner rings 19, 20 and of the outer rings 21, 22. They are also placed concentrically relative to the torsion element 11.

The electronic circuit board 14 is furnished with processing means 14a, for example in the form of a processor, capable of processing the output signals from the six sensor elements, for example by differentiation two by two, by means of operational amplifiers, in an analog or digital manner. The processing means may then calculate the square root of the sum of the squares of the differences between the signals to obtain a value representative of the angular difference between the encoders 29 and 30 and consequently representative of the torque exerted on the flexible element 11 in torsion and consequently in the steering column.

This embodiment makes it possible to obtain a torque measurement simply and economically by means of an electronic circuit board. It is possible to send as an output a signal representative of the torque and also a signal representative of the angular position of the steering wheel, to the extent that the sensor elements placed on the side of the column situated toward the steering wheel provide an angular position signal representing with precision the angular position of the steering wheel. It is therefore possible, moreover, to dispense with any angular position sensor placed close to the steering wheel.

The embodiment illustrated in FIGS. 3 and 4 is relatively similar to that illustrated in FIG. 2, while also comprising multirevolution counting means. Specifically, a steering wheel may usually be turned several revolutions, often in the order of four, by the driver of the vehicle, from one stop to the other, in other words from a maximum turning position to the left of the steering wheels of the vehicle to an opposite maximum position to the right. In certain applications, it is desirable to know the angular position of the steering wheel on several turns. As an example, an angular position, indicated only by a value of the type +50°, may correspond to +50° relative to neutral, +50° relative to +1 turn, +50° relative to −1 turn, or else +50° relative to −2 turns of the steering wheel.

As illustrated in FIGS. 3 and 4 in which identical elements bear the same reference numbers, the casing 15 has, in addition to its general cylindrical annular shape, an excrescence 40 directed radially outward and releasing an additional inner space 41, making it possible to house additional pieces inside said casing 15. The space 41 communicates with the space previously described formed between the transverse surfaces of the rolling bearing rings and radially around the outer cylindrical surface of the flexible element 11 in torsion. The excrescence 40 is shared between the parts 35 and 36 of the casing 15 so that pieces can be easily placed in the casing 15 before the two parts 35 and 36 are installed. The electronic circuit board 14 comprises a lug 42, protruding radially outward and placed in said space 41, in contact with a radial portion 43 of the part 36 of the casing 15. The lug 42 allows, on the one hand, an easy angular positioning of the electronic circuit board 14 in the casing 15 and, on the other hand, makes it possible to support two magnetism-sensing sensors 44 and 45. The magnetism-sensing sensors 44 and 45 are placed on the side of the lug 42 opposite to the radial portion 43 of the casing 15.

The part 35 of the casing 15 also comprises a radial portion 46, of similar shape to the radial portion 43 of the part 36, and an axial finger 47 extending from the radial portion 46 toward the radial portion 43, while remaining recessed relative to the end of the portion 35. The axial finger 47 is placed radially close to the outer surface of the outer ring 21 of the rolling bearing 12. Onto the finger 47, a gearwheel 48 is rotatably mounted, for example made of a synthetic material, provided with external teeth 49 visible in FIG. 5.

In the embodiment illustrated in FIG. 5, the gearwheel 48 comprises eight teeth and is in the form of an eight-pointed star.

In the embodiment illustrated in FIGS. 3 and 4, the gearwheel comprises twelve teeth. The gearwheel 48 is furnished with a magnetized band 50 forming a bipolar ring, each pole occupying an angular sector of 180°. The bipolar ring 50 is placed facing the sensors 44, 45 with an axial air gap. The support part 31 of the encoder 29 is furnished with a short radial collar 51 extending outward, placed axially between the active part 33 and the transverse surface of the inner ring 19. The radial collar 51 is provided with teeth designed to interact with the teeth 49 of the gearwheel 48. The teeth of the radial collar 51 may, as an example, number two teeth 52, 54 formed immediately next to a hollow 53. Therefore, one rotation in one revolution of the encoder 29 corresponding substantially to one rotation in one revolution of the steering wheel causes the teeth 52 and 54 to mesh with a corresponding number of teeth, namely two teeth 49, thereby causing the gearwheel 48 to rotate over an arc of a circle equal to two divided by the number of teeth, for example eight in the embodiment illustrated in FIG. 5, namely a quarter of a turn.

Specifically, as illustrated in FIG. 5, the magnetic sensor 44 is facing a North pole of the gearwheel 49, while the magnetic sensor 45 is facing a South pole. In the case of a rotation of a quarter of a turn of the gearwheel 48 in the clockwise direction, the two magnetic sensors 44 and 45 are placed facing the North pole. In the case of a rotation of half a turn of the gearwheel 48, the magnetic sensor 44 sees a South pole, while the magnetic sensor 45 sees a North pole, and finally, in the case of a rotation of a quarter of a turn in the counterclockwise direction of the gearwheel 48, the magnetic sensors 44 and 45 both see the South pole.

The magnetic sensors 44 and 45 may be designed to transmit a binary signal as an output, the value zero corresponding to one of the poles and the value one corresponding to the opposite poles. The result of this is that there are four possible combinations of output signals from the sensors 44 and 45 corresponding to the four possible turns of a steering column shaft. The output signals from the magnetic sensors 44 and 45 therefore indicate, when they are powered up, the position of the steering column shaft in terms of number of turns, which may be expressed either relative to the neutral position with a number of turns −2, −1, +1 or 2, or else relative to one of the end stops with a position in number of turns expressed by a figure of 1 to 4. The processing means of the electronic circuit board 14 is configured to combine the output signals from the revolution counter thus formed with the output signals from one of the sensor assemblies, for example that formed by the sensor elements placed facing the encoder connected to the upstream of the steering column, that is to say to the steering wheel, in order to increase the precision of the measurement.

In one embodiment, the reduction ratio between the gearwheel 48 and the toothed collar 51 is equal to the number of turns of the steering wheel from one stop to the other.

In the embodiment illustrated in FIGS. 6 and 7, the reference numbers of the similar elements have been retained. The central part 16b has a diameter ranging between the diameter of the first part 16a and the diameter of the small-diameter part 16c. The inner ring 20 of the rolling bearing 13 is sleeve-fitted onto the outer surface of the central part 16b and butts against a shoulder separating the central part 16b from the first part 16a.

The sleeve 17 also has a tiered outer surface, the inner ring 19 of the rolling bearing 12 being in contact with the shoulder separating two portions of outer surface of different diameter. The casing 15 is extended radially inward by flanges formed in the vicinity of the sealing flanges 27 and 28 of the rolling bearings 12 and 13 and allowing increased protection by forming a narrow passageway on one side with the sleeve 17 and on the other side with the first part 16a. The casing 15 also comprises axial edges 35a, 36a directed inward and into which the outer rings 21 and 22 of the rolling bearings 12 and 13 are respectively sleeve-fitted.

Onto the outer ring 22 of the rolling bearing 13 a sleeve 55 is sleeve-fitted, one end of which comes close to the axial edge 36a of the part 36 of the casing 15. The sleeve 55 also comprises a radial protrusion directed inward, making it possible to determine its axial position by contact with the corresponding radial transverse face of the outer ring 22 and supports a band 56 sleeve-fitted into the sleeve 55 on the side opposite to the outer ring 22, said band 56, for example made of a synthetic material, being fixed to the electronic circuit board 14.

In a similar manner, a sleeve 57 is sleeve-fitted onto the outer ring 21 of the rolling bearing 12 and supports an open band 58 sleeve-fitted into said sleeve 57, the open band 58 being fixed to the electronic circuit board 14. The sleeve 57 comprises a circumferentially localized excrescence 59, in which a hole is made making it possible to house the shaft 60 supporting the gearwheel 48. The gearwheel 48 is furnished at its center with an encoder 50, for example a rectangular-shaped magnet or a plurality of magnets conveniently placed facing the magnetic sensor 44 fixed to the electronic circuit board 14.

In addition, the casing 15 is furnished with joining members 61 between the parts 35 and 36 and has a cable outlet 62.

The electronic circuit board 14 is therefore perfectly well positioned, both with respect to the encoder 29 and the encoder 30, which ensures excellent stability of the signal.

As illustrated in FIG. 8, the band 56 comprises three feet 65 in contact with the electronic circuit board 14, of annular shape. The feet 65 protrude axially relative to the body of the band 56 and have a thin portion in which the holes for fixing the fasteners 66 of the sensor elements 39 are made. The open band 58 is also provided with three feet 65 evenly distributed circumferentially and in contact with the opposite face of the electronic circuit board 14, the feet 65 being formed at a distance from the opening of the band 58. The device also comprises at least two goujon pins 64 passing through the holes made in the open band 58, in the electronic circuit board 14 and in the band 56. The goujon pins 64 make it possible to hold these three pieces together, for example by bonding. The goujon pins 64 are placed in diametrically opposed positions, at a distance from the feet 65, so as not to interfere with the fixing of the sensor elements 38 and 39.

As a result the user benefits from a torque detection device also capable of supplying an angular position signal, from the input part or from the output part depending on the installation adopted and also capable of forming a revolution counter in order to supply the absolute multi-turn angular position of the shaft.

The device is considerably simpler and more compact than the devices known in the prior art which are based on a large number of sensors and electronic circuit boards and relatively long cables to supply such complete signals.

1. A device for detecting torque transmitted by a shaft, comprising:
a torsion element having an input portion and an output portion,
first and second encoders, the first encoder being angularly connected to the input portion of the torsion element, the second encoder being connected to the output portion of the torsion element,
a sensor assembly configured to interact with the first and second encoders and configured to transmit a first output signal representative of a first parameter of rotation of the input portion of the torsion element and a second output signal representative of a second parameter of rotation of the output portion of the torsion element, the sensor assembly being disposed on an element fixed between the first and second encoders and including a first side directed toward the first encoder and a second side directed toward the second encoder and
a processing means receiving the first and second output signals from the sensor assembly and configured to generate a signal representative of the torque exerted on the flexible element in torsion, and
two rolling bearings disposed within a casing, the fixed element being disposed between the two bearings and fixed in the casing, the first and second encoders each being supported by a separate one of the rolling bearings.

2. The device as claimed in claim 1, wherein each of the two rolling bearings includes an inner ring and an outer ring, the sensor assembly and the encoders being disposed radially between the inner rings and the outer rings of the two rolling bearings.

3. The device as claimed in claim 1, wherein the two rolling bearings are configured to support the torsion element, the first and second encoders are disposed concentrically about the torsion element.

4. The device as claimed in claim 1, wherein the fixed element includes an electronic circuit board configured to support the sensor assembly.

5. The device as claimed in claim 4, wherein the electronic circuit board includes means for processing the signals transmitted by the first and second sensor elements of the sensor assembly.

6. The device as claimed in claim 1, wherein the processing means is configured to generate an output signal representative of the angular position of at least one of the first and second encoders.

7. The device as claimed in claim 1, wherein the one of the two rolling bearings includes a first raceway located proximal to the input portion of the torsion element, and the other one of the two rolling bearings includes a second raceway located proximal to the output portion of the torsion element, the first encoder being rotationally connected to the first raceway, and the second encoder being rotationally connected to the second raceway.

8. The device as claimed in claim 7, wherein at least one of the first raceway is disposed about the input portion of the torsion element and the second raceway is disposed about the output portion of the torsion element.

9. The device as claimed in claim 7, wherein at least one of the first raceway is provided by a first inner ring disposed about the input portion of the torsion element and the second raceway is provided by a second inner ring disposed about the output portion of the torsion element.

10. The device as claimed in claim 4, wherein the two rolling bearings include an outer ring furnished with two raceways, the electronic circuit board being mounted so as to remain in a fixed position relative to said outer ring.

11. The device as claimed in claim 4, wherein a first one of the two bearings includes a first inner ring and a first outer ring, a second one of the two bearings includes a second inner ring and a second outer ring, the electronic circuit board being mounted so as to remain in a fixed position relative to the first and second outer rings.

12. The device as claimed in claim 4, wherein the sensor assembly includes a first sensor disposed on one side of the electronic circuit board and configured to generate the first signal and a second sensor disposed on the other side of the electronic circuit board and configured to generate the second signal.

13. The device as claimed in claim 1, further comprising a revolution counter configured to supply a signal representative of a number of revolutions of the shaft.

14. The device as claimed in claim 4, wherein the electronic circuit board is disposed between the first and second encoders.

15. The device as claimed in claim 12, wherein at least one of the first sensor and the second sensor includes three detection elements.

16. The device as claimed in claim 4, wherein the electronic circuit is configured to generate an output signal representative of the absolute angular position of at least one of the first and second encoders.

17. The device as claimed in claim 4, wherein the electronic circuit is configured to generate an output signal representative of the relative angular position of at least one of the first and second encoders and an output signal representative of the absolute angular position of another encoder.

18. A steering-column device comprising:
a device for detecting torque transmitted by a shaft including:
a torsion element having an input portion and an output portion,
first and second encoders, the first encoder being angularly connected to the input portion of the torsion element, the second encoder being connected to the output portion of the torsion element,
a sensor assembly configured to interact with the first and second encoders and configured to transmit a first output signal representative of a first parameter of rotation of the input portion of the torsion element and a second output signal representative of a second parameter of rotation of the output portion of the torsion element, the sensor assembly being disposed on an element fixed between the first and second encoders and including a first side directed toward the first encoder and a second side directed toward the second encoder,
a processing means receiving the output signals from the sensor assembly and configured to generate a signal representative of the torque exerted on the flexible element in torsion, and
two rolling bearings disposed within a casing, the fixed element being disposed between the two bearings and fixed in the casing, the first and second encoders each being supported by a separate one of the rolling bearings,
a first steering part connected to the torsion element input portion, and
a second steering part connected to the torsion element output portion.
